(19) United States
(12) Patent Application Publication
(10) Pub. No.: US 2011/0019262 A1
(43) Pub. Date: Jan. 27, 2011

(54) DISPLAY DEVICE

(75) Inventor: Noriko Watanabe, Osaka-shi (JP)

Correspondence Address: SHARP KABUSHIKI KAISHA;C/O KEATING & BENNETT, LLP, 1800 Alexander Bell Drive, SUITE 200, Reston, VA, 20191, US

(73) Assignee: SHARP KABUSHIKI KAISHA, Osaka-shi, Osaka (JP)

(21) Appl. No.: 12/922,178

(22) PCT Filed: Feb. 6, 2009
(86) PCT No.: PCT/JP2009/000486

§ 371 Date: Sep. 13, 2010

(30) Foreign Application Priority Data
May 19, 2008 (JP) 2008-131189

(51) Int. Cl. G02B 26/00; G02F 1/13357

(52) U.S. Cl. 359/290; 349/61

(57) ABSTRACT

A display device includes a display element including a plurality of first sub-pixels, a color filter element stacked on the display element, and including a plurality of second sub-pixels arranged to overlap the respective first sub-pixels, and a light source emitting white light toward the color filter element and the display element. The display device performs display with light from the light source transmitted through the first sub-pixels and the second sub-pixels. Each of the second sub-pixels of the color filter element includes a color region of which area is changed by electrowetting.

### TECHNICAL FIELD

The present invention relates to display devices, and more particularly to improvements in brightness in displaying white.

### BACKGROUND ART

In recent years, thin display devices such as liquid crystal display devices have been widely used in various fields. Display quality of liquid crystal display devices have been improved year by year, and most liquid crystal display devices exhibit higher display performance than cathode ray tubes. However, improvements in white brightness are still expected.

In a liquid crystal display device, since a backlight having uniform brightness over the entire display screen is used, the brightness where the entire display screen performs white display is the same as the brightness (peak brightness) where the display screen performs local white display. On the other hand, a light emitting display such as a cathode ray tube has excellent expression characteristics in locally displaying white, since brightness of the area for displaying white can be increased by reducing the area.

Recently, increasing attention has been given to environmental issues, and reduction in power consumption in liquid crystal display devices has been required. Thus, if brightness of display in liquid crystal display devices can be improved, brightness of backlights can be reduced to decrease power consumption. As a method of improving brightness, for example, Patent Document 1 suggests a liquid crystal display device of an RGBW system provided with a transparent filter (W) in addition to red, green, and blue (RGB) filters of an RGB system.

Furthermore, for example, Patent Document 2 teaches a display device utilizing the principle of electrowetting. Electrowetting is a technique of controlling hydrophilic properties of surfaces of hydrophobic films by applying voltages and is utilized for switching light. Recently, usage of electrowetting for reflective electronic paper and the like has been researched.

A structure of a display will be briefly described. A first substrate and a second substrate are arranged to face each other with a partition wall interposed therebetween. Water and colored oil are enclosed in space formed inside the substrates. The first substrate is formed by stacking a transparent electrode, an insulating film, and a hydrophobic film having a hydrophobic surface in this order. On the other hand, the second substrate is provided with a transparent electrode at the side of the first substrate. Then, an oil layer is provided on the surface of the hydrophobic film, and water is filled between the oil layer and the second substrate.

When no voltage is applied to the transparent electrodes, the surface of the hydrophobic film becomes hydrophobic, and the entire surface is covered by the oil. On the other hand, when a voltage is applied, the surface of the hydrophobic film changes to hydrophilic. Then, the oil is pushed away from the surface of the hydrophobic film, and the surface is covered by water.

Then, the reflective display device is formed by using oil colored cyan, magenta, yellow (CMY) and arranging a reflective plate on the first substrate which is the back surface.

### Patent Document

PATENT DOCUMENT 1: Japanese Patent Publication No. H10-10998

PATENT DOCUMENT 2: Japanese Translation of PCT International Application No. 2007-508576

### SUMMARY OF THE INVENTION

### Technical Problem

However, even when color filters of an RGBW system are used as in Patent Document 1, a sufficient advantage in improving brightness cannot be obtained.

Advantages in improving white brightness in the RGBW system will be described below. As shown in the upper half of FIG. 6, assume that brightness of white displayed by transmitting light through the colors of RGB and mixing the colors is 1 in an RGB system in which the three colors of RGB have equal areas.

As shown in the lower half of FIG. 6, in an RGBW system in which the colors of RGBW have equal areas, white brightness of transmitted light in the RGB part is 1×¾ as calculated from the area ratio. The white brightness in the W part is triple as high as that in the RGB part. (It can be usually assumed that about ⅓ of white light of a backlight is transmitted through each of the colors.) Since the area of the W part is ¼ of the entire area, the brightness is ¾ as calculated from 3×¼. Therefore, the entire RGBW system provides brightness improved only 1.5 times as much as the RGB system.

Furthermore, as described above, a sub-pixel size in each color in the RGBW system is ¾ as large as that in the RGB system. Thus, when a single color of RGB is displayed, for example, in the case of the single color (deep color) of R, the colors of GBW are shielded from light and light is transmitted only through R sub-pixels. There is the disadvantage that R displaying is dark, since the sub-pixel size is small.

The present invention is made to address such problems. It is an objective of the present invention to improve brightness in displaying white in display devices.

### Solution to the Problem

In order to achieve the objective, in the present invention, a color filter element in which an area of a color region is changed by electrowetting is stacked on a display element.

Specifically, a display device according to the present invention includes a display element including a plurality of first sub-pixels, a color filter element stacked on the display element and including a plurality of second sub-pixels arranged to overlap the respective first sub-pixels of the display element, and a light source emitting white light toward the color filter element and the display element. The display device performs display with light from the light source transmitted through the first sub-pixels and the second sub-pixels. Each of the second sub-pixels of the color filter element includes a color region of which area is changed by electrowetting.

The color filter element preferably includes a plurality of pixels each of which includes a group of one of the second sub-pixels having a red (R) color region, one of the second sub-pixels having a green (G) color region, and one of the second sub-pixels having a blue (B) color region.

The display element may be a liquid crystal display element.

The display element may be an electrowetting display element.

The color filter element includes a first substrate, and a second substrate facing the first substrate with a partition wall segmenting the second sub-pixels interposed therebetween. A first transparent electrode, an insulating film, and a hydrophobic film are sequentially stacked on the first substrate. A second transparent electrode is stacked on the second substrate. Hydrophilic first solution and hydrophobic second solution, either one of which is colored, are enclosed between the second transparent electrode and the hydrophobic film in the second sub-pixels. A voltage supply for applying a voltage between the first and second transparent electrodes is connected to the first and second transparent electrodes. A surface of the hydrophobic film at the side of the second substrate is hydrophobic when the voltage supply applies no voltage between the first and second transparent electrodes, and is hydrophilic when the voltage supply applies a voltage between the first and second transparent electrodes.

The first solution is preferably water, and the second solution is preferably oil.

The hydrophobic film is preferably formed of an SiO₂ film having an OH group on a surface.

### Operation

Next, operation in the present invention will be described.

The display device performs display by allowing white light emitted from the light source to be transmitted through both of the first sub-pixels of the display element and the second sub-pixels of the color filter element. In each of the second sub-pixels of the color filter element, the area of the color region is changed by electrowetting. Specifically, when the area of the color region in the second sub-pixel increases, colored light transmitted through the color region performs color display of the second sub-pixel. On the other hand, when the area of the color region in the second sub-pixel decreases, white light transmitted through the second sub-pixel performs white display.

Thus, according to the present invention, white display is performed not by color mixture, but by white light itself from the light source transmitted through the second sub-pixel with a decreased area of the color region. Therefore, brightness in displaying white is greatly improved.

Furthermore, there is no need to provide a W region for displaying white as in an RGBW system. Thus, the area for the color region in the second sub-pixel can be sufficiently obtained not to reduce brightness in displaying a color.

### Advantages of the Invention

According to the present invention, a color filter element, in which an area of a color region is changed by electrowetting, is stacked on a display element. This enables displaying of white with white light itself from a light source transmitted through at least a part of a second sub-pixel with a decreased area of a color region. Therefore, brightness in displaying white can be largely improved compared to the case where white display is performed by color mixture.

Furthermore, there is no need to provide a W region for displaying white, as for example, in an RGBW system, the area of a color region in a second sub-pixel can be sufficiently obtained, thereby significantly improving brightness in displaying white as well as in displaying a color.

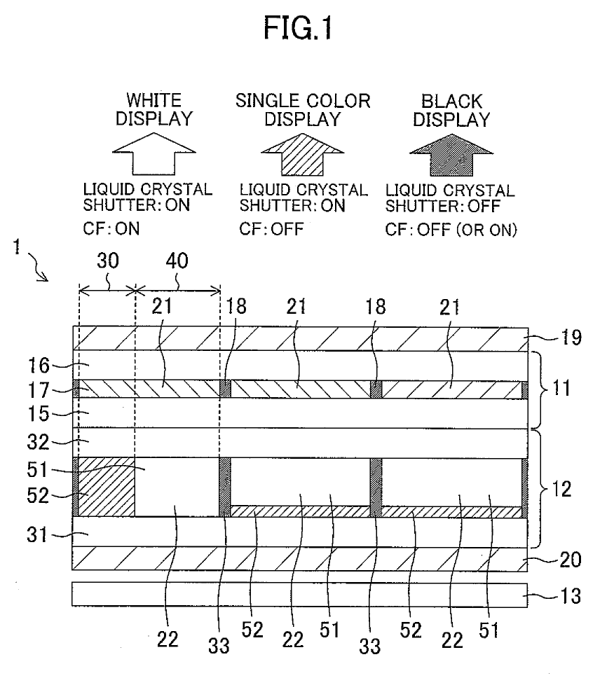

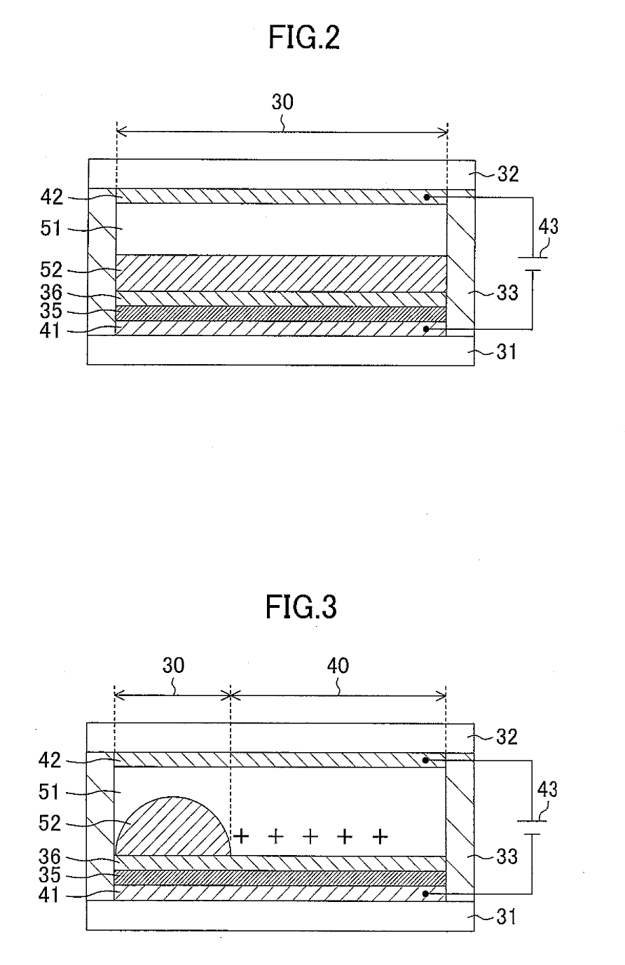

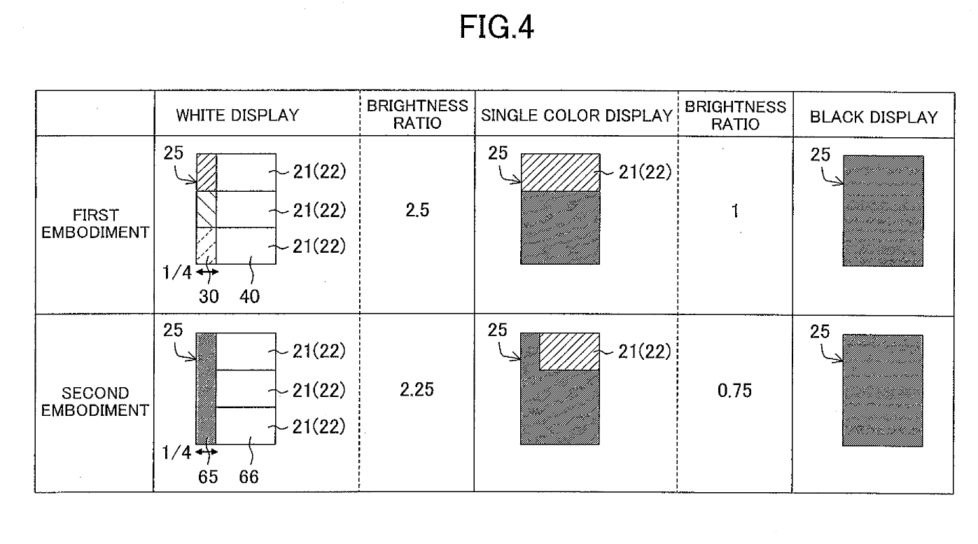

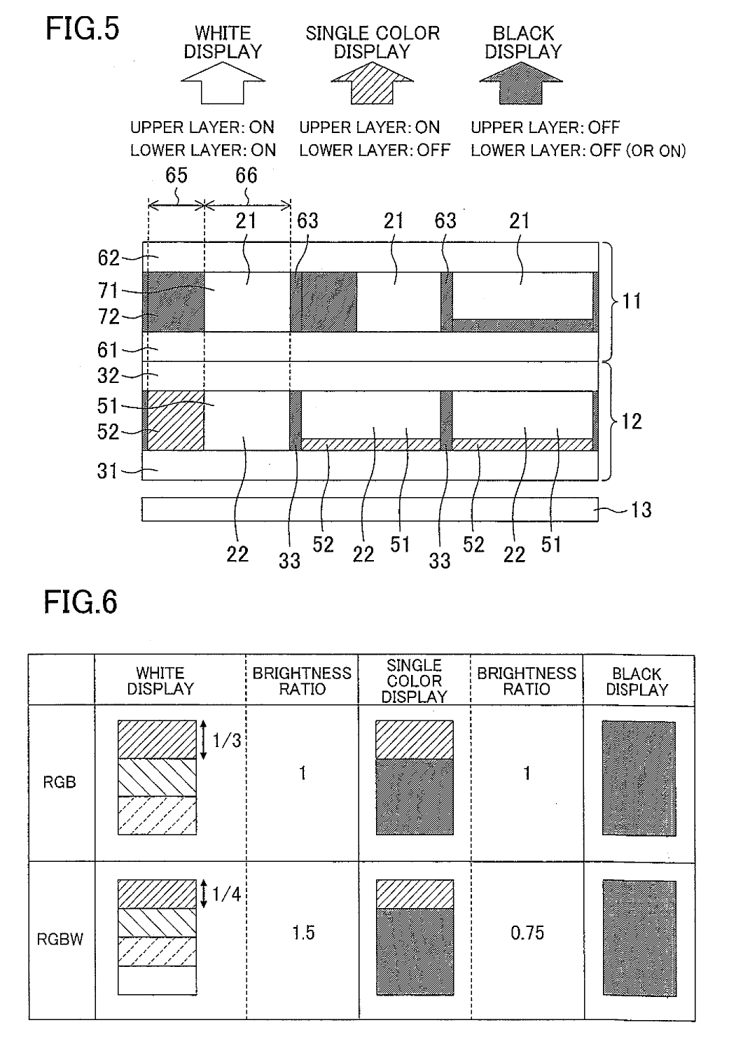

### BRIEF DESCRIPTION OF THE DRAWINGS

[FIG. 1] FIG. 1 is a cross-sectional view schematically illustrating the structure of a display device in a first embodiment.

[FIG. 2] FIG. 2 is a cross-sectional view schematically illustrating a color filter element to which no voltage is applied.

[FIG. 3] FIG. 3 is a cross-sectional view schematically illustrating the color filter element to which a voltage is applied.

[FIG. 4] FIG. 4 illustrates states of pixels when displaying white, a single color, and black in the first and second embodiments.

[FIG. 5] FIG. 5 is a cross-sectional view schematically illustrating the structure of a display device in a second embodiment.

[FIG. 6] FIG. 6 illustrates states of pixels in displaying white, a single color, and black in an RGB system and an RGBW system.

### DESCRIPTION OF REFERENCE CHARACTERS

1 Liquid Crystal Display Device
11 Liquid Crystal Display Element (Display Element)
12 Color Filter Element
13 Backlight Unit
21 First Sub-Pixel
22 Second Sub-Pixel
25 Pixel
30 Color Region
31, 61 First Substrates
32, 62 Second Substrates
33, 63 Partition Walls
35 Insulating Film
36 Hydrophobic Film
40 Colorless Region
41 First Transparent Electrode
42 Second Transparent Electrode
43 Voltage Supply
51, 71 Water (First Solution)
52, 72 Oil (Second Solution)
65 Black Region
66 Colorless Region

### DESCRIPTION OF EMBODIMENTS

Embodiments of the present invention will be described hereinafter in detail with reference to the drawings. Note that the present invention is not limited to the following embodiments.

### First Embodiment of Invention

FIGS. 1-3 illustrate a first embodiment of the present invention.

FIG. 1 is a cross-sectional view schematically illustrating the structure of a display device in the first embodiment. FIG. 2 is a cross-sectional view schematically illustrating a color filter element to which no voltage is applied. FIG. 3 is a cross-sectional view schematically illustrating a color filter element to which a voltage is applied.

The display device in the first embodiment is a liquid crystal display device 1 providing transmissive display. As shown in FIG. 1, the display device includes a liquid crystal display element 11 as a display element, a color filter element 12 stacked on the liquid crystal display element 11, and a backlight unit 13 as a light source located at the side of the color filter element 12 opposite to the liquid crystal display element 11.

The backlight unit 13 is configured to emit white light toward the color filter element 12 and the liquid crystal display element 11. The white light emitted from the backlight unit 13 has substantially uniform brightness over the entire emitting surface.

The liquid crystal display element 11 includes a TFT substrate 15, an opposing substrate 16 facing the TFT substrate 15, and a liquid crystal layer 17 enclosed between the TFT substrate 15 and the opposing substrate 16. The liquid crystal display element 11 also includes a plurality of first sub-pixels 21 as unit regions of displaying. The first sub-pixels 21 are for example, arranged in a matrix.

The TFT substrate 15 is, for example, a glass substrate as a transparent substrate including the first sub-pixels 21 each of which includes a sub-pixel electrode (not shown) and a thin-film transistor (TFT). Gate lines and source lines (not shown) connected to the TFTs are formed in a lattice. The lines are covered by an insulating film (not shown), of which surface is provided with an opposing film (not shown).

The opposing substrate 16 is, for example, a glass substrate as a transparent substrate including a common electrode (not shown) formed uniformly over the substantially entire surface. A predetermined voltage is applied between the common electrode and the sub-pixel electrode to control orientation of the liquid crystal layer 17 in each of the first sub-pixels 21. Light-shielding portions 18 segmenting the first sub-pixels 21 are provided between the TFT substrate 15 and the opposing substrate 16. A polarizer 19 is bonded to an outer surface of the opposing substrate 16, i.e., a surface opposite to the liquid crystal layer 17.

The liquid crystal display element 11 can be manufactured, for example, by bonding the TFT substrate 15 to the opposing substrate 16 with a sealing member (not shown) like a frame, and by injecting a liquid crystal material from an inlet formed in the sealing member into space between the substrates 15 and 16.

The color filter element 12 includes, as shown in FIGS. 1 and 2, a first transparent substrate 31 made of, e.g., glass, and a second transparent substrate 32 facing the first substrate 31 with partition walls 33 interposed therebetween and made of, e.g., glass. The color filter element 12 includes a plurality of second sub-pixels 22 arranged to overlap the respective first sub-pixels 21 of the liquid crystal display element 11. That is, the second sub-pixels 22 are arranged in a matrix corresponding to the first sub-pixels 21. The second sub-pixels 22 are segmented by the partition walls 33.

As a feature of the present invention, each of the second sub-pixels 22 of the color filter element 12 includes a color region 30 of which area is changed by electrowetting. Furthermore, the liquid crystal display device 1 is configured to perform display with light from the backlight unit 13 transmitted through the first sub-pixels 21 and the second sub-pixels 22.

The color filter element 12 includes a plurality of pixels 25 each of which includes a group of: one of the second sub-pixels 22 having a color region 30 of red (R), one of the second sub-pixels 22 having a color region 30 of green (G), and one of the second sub-pixels 22 having a color region 30 of blue (B).

As shown in FIG. 2, a first transparent electrode 41 as a sub-pixel electrode, and a TFT (not shown) for switch-driving the first transparent electrode 41 are formed in each of the second sub-pixels 22 on the first substrate 31. The first transparent electrode 41 is made of, e.g., ITO. An insulating film 35 and a hydrophobic film 36 are sequentially stacked on the first transparent electrode 41 and the TFT. The insulating film 35 is made of, e.g., SiO₂. Furthermore, a polarizer 20 is bonded to the surface of the first substrate 31 opposite to the second substrate 32.

On the other hand, a second transparent electrode 42 made of, e.g., ITO, is stacked on the surface of the second substrate 32 at the side of the first substrate 31. A voltage supply 43 for applying a predetermined voltage between the first transparent electrode 41 and second transparent electrode 42 is connected to the first transparent electrode 41 and the second transparent electrode 42. The TFT is interposed between the first transparent electrode 41 and the voltage supply 43.

Furthermore, hydrophilic first solution 51 and hydrophobic second solution 52, either one of which is colored, are enclosed between the second transparent electrode 42 and the hydrophobic film 36 in the second sub-pixels 22. In the first embodiment, the first solution 51 is colorless transparent water and the second solution 52 is oil colored red (R), green (G), or blue (B).

The hydrophobic film 36 is, for example, an SiO₂ film having an OH group on the surface at the side of the second substrate 32. A surface of the hydrophobic film 36 at the side of the second substrate 32 is hydrophobic when the voltage supply 43 applies no voltage between the first transparent electrode 41 and the second transparent electrode 42, and is hydrophilic when the voltage supply 43 applies a voltage between the first transparent electrode 41 and the second transparent electrode 42.

The color filter element 12 can be manufactured by, for example, forming the partition walls 33 on the first substrate 31 including the first transparent electrode 41, the insulating film 35, the hydrophobic film 36, and the like; injecting the oil 52 and the water 51 between the partition walls 33; and then bonding the second substrate 32 provided with the second transparent electrode 42 to the first substrate 31.

Next, operation of the liquid crystal display device 1 will be described.

The liquid crystal display element 11 functions as a shutter controlling the amount of transmitted light, and controls grayscale rendering. When a liquid crystal shutter of the liquid crystal display element 11 is on, light is transmitted through the liquid crystal display element 11 to perform white display or color display. On the other hand, when the liquid crystal shutter is off, the liquid crystal display element 11 shields transmission of light to perform black display.

The color filter element 12 switches to a color display mode or a white display mode when the liquid crystal shutter is on.

Specifically, the TFT in each of the second sub-pixels 22 of the color filter element 12 is driven by a switch to perform white display when the color filter element 12 is on, and color display when the color filter element 12 is off.

First, when displaying white, as shown in FIGS. 1 and 4, the liquid crystal shutters of all the first sub-pixels 21 in the pixels 25 are turned on. Furthermore, the voltage supply 43 supplies a voltage between the first transparent electrode 41 and the second transparent electrode 42 to turn on all the second sub-pixels 22 in the color filter element 12. Then, the hydrophobic film 36 is hydrophilic in each of the second sub-pixels 22 of RGB, and thus, as shown in FIG. 2, the surface of the hydrophobic film 36 having hydrophilicity is covered by the water 51, and the oil 52 is pushed away to one of the partition wall 33. As a result, the area of the color region 30 decreases to increase the area of a colorless region 40 of the hydrophobic film 36 which is in contact with the water 51.

As such, light from the backlight unit 13 remains white light to be transmitted through the colorless regions 40 in three of the second sub-pixels 22 of each of the pixels 25. On the other hand, in three of the second sub-pixels 22 of the pixel 25, light transmitted through each of the color region 30 of RGB is mixed to be white light in the pixel 25 as a whole. The white light performs white display.

When displaying white, the smaller the area of the oil 52 in the second sub-pixels 22 is, the more white brightness can be improved. When the area is ½ or less of the entire area, twice or more high brightness as compared to a conventional RGB system can be obtained.

In the first embodiment, the area of the oil 52 in displaying white is, for example, ¼ of the entire area. Where white brightness of a conventional RGB system is 1, the brightness ratio in the first embodiment is obtained as follows, as shown in the upper half of FIG. 4. The ratio in the mixed color portion of RGB is ¼ calculated by ¼×brightness 1, and the ratio in the white display portion is ¾×brightness 3= 9/4. Thus, the ratio in the entire pixel 25 is 2.5 times as high as that in the conventional RGB system.

Next, when displaying a color (a single color), as shown in FIGS. 1 and 4, the liquid crystal shutter of one of the first sub-pixels 21 included in the pixel 25 is turned on, and the liquid crystal shutters of the other two first sub-pixels 21 are off. For example, when displaying red (R), only the liquid crystal shutters of the first sub-pixels 21, which overlap the red second sub-pixels 22, are turned on. Furthermore, in the red second sub-pixels 22 of the color filter element 12, no voltage is applied between the first transparent electrode 41 and the second transparent electrode 42 to turn off the red second sub-pixels 22.

Then, in the red second sub-pixels 22 to which no voltage is applied, the entire surface of the hydrophobic film 36 is covered by red oil 52 as shown in FIG. 1, since the hydrophobic film 36 is hydrophobic. As a result, light transmitted through the red oil 52 performs red-color display. Color display of green (G) and blue (B) are similarly performed.

Next, when displaying black, as shown in FIGS. 1 and 4, liquid crystal shutters of the liquid crystal display element 11 are turned off to shield light from the backlight unit 13. At this time, for example, in three of the second sub-pixels 22 included in the pixels 25, no voltage is applied between the first transparent electrode 41 and the second transparent electrode 42 to turn off the second sub-pixels 22. Note that the color filter element 12 may be turned on or off.

### Advantages in First Embodiment

As described above, according to the first embodiment, the color filter element 12 in which the areas of the color regions 30 are changed by electrowetting is stacked on the liquid crystal display element 11. Thus, white display can be performed by white light itself from the backlight unit 13 transmitted through part of the second sub-pixels 22 in which the areas of color regions 30 decrease (i.e., the areas of the colorless regions 40 increase). Therefore, brightness in displaying white is largely improved as compared to white display performed by color mixture.

Specifically, in displaying white, a voltage is applied between the first transparent electrode 41 and the second transparent electrode 42 to reduce the area of the color regions 30 (i.e., the regions in which the oil 52 covers the hydrophobic film). This reduces the ratio of white display performed by the color mixture of light transmitted through the color regions 30 with the reduced areas. On the other hand, the ratio of white display performed by white light transmitted without being colored through the colorless regions 40 (the areas in which the water 51 covers the hydrophobic film 36) with the increased areas can be increased. This significantly improves brightness in displaying white.

Furthermore, in the first embodiment, there is no need to provide a W region for displaying white as for example, in an RGBW system. This sufficiently ensures the area of the color region 30 in each of the second sub-pixels 22 when displaying a color, thereby preventing the displaying of the color (single color) being dark. That is, according to the first embodiment, brightness in displaying a color can be significantly improved, while improving brightness in displaying white.

### Second Embodiment of Invention

FIG. 5 illustrates a second embodiment of the present invention. FIG. 5 is a cross-sectional view schematically illustrating the structure of a display device in the second embodiment. Note that in the following embodiments, the same reference characters as those shown in FIGS. 1-3 are used to represent equivalent elements, and the explanation thereof will be omitted.

While the display element in the above first embodiment is the liquid crystal display element 11, an electrowetting display element 11 is used as a display element in the second embodiment. That is, in the second embodiment, both of the display element 11 and the color filter element 12 include shutter elements in an electrowetting system.

The structure of the display element 11 will be described hereinafter with reference to the drawings below.

The display element 11 has the same structure as the color filter element 12, but is different from the color filter element 12 in which oil 72 is colored black. Specifically, the display element 11 includes, as shown in FIG. 5, a transparent first substrate 61 made of, e.g., glass, and a transparent second substrate 62 facing the first substrate 61 with a partition wall 63 interposed therebetween and made of, e.g., glass. The display element 11 includes a plurality of first sub-pixels 21 arranged, for example, in a matrix and segmented by partition walls 63. Each of the first sub-pixels 21 is provided with a sub-pixel electrode (not shown) and a TFT (not shown) as the color filter element 12 is.

The first substrate 61 and the second substrate 62 have the same structures as the first substrate 31 and the second substrate 32 of the color filter element 12, respectively. The black oil 72 and water 71 are enclosed in each of the first sub-pixels 21. Then, a voltage is applied to each of the first sub-pixels 21 to change the area of a black region 65, in which is a hydrophobic film (not shown) is covered by the black oil 72.

As such, when the shutter of the display element 11 is turned off, the area of the black region 65 is increased to cover the entire first sub-pixels 21 by the oil 72, thereby performing black display. When the shutter of the display element 11 is turned on, the area of the black region 65 is reduced to form a colorless region 66 in the first sub-pixels 21, thereby performing white display or color display (single color display) by light transmitted through the second sub-pixels 22 and the colorless region 66 of the color filter element 12.

The lower half of FIG. 4 illustrates display patterns and brightness in the second embodiment. When displaying white, for example, ¼ of the pixel 25 is shielded as the black region 65, and thus, the white brightness is 2.25, where white brightness in a conventional RGB system is 1.

When displaying a color (a single color), ¼ of the first sub-pixels 21 performing color display are shielded as the black region 65, and thus, the brightness of the color light is 0.75 times as high as that in the conventional RGB system.

### Advantages in Second Embodiment

Therefore, also in the second embodiment, both of white brightness and brightness of a single color are slightly decrease as compared to those in the first embodiment using the liquid crystal display element 11. However, white display is performed by white light itself from the backlight unit 13 using the color filter element 12 in an electrowetting system, and thus, brightness in displaying white can be largely improved.

### Other Embodiments

While in the first embodiment, grayscale rendering is controlled in the liquid crystal display element 11, gray scale may be controlled in the color filter element 12. Specifically, by controlling a voltage value applied to the first transparent electrode 41 and the second transparent electrode 42, the areas of the color regions 30 (i.e., the areas of the colorless regions 40) are changed to control gray scale.

In the second embodiment, gray scale may be controlled by controlling a voltage applied to a display element 11 in an electrowetting system.

While in the first and second embodiments, examples have been described where the oil 52 is colored, the water 51 may be colored instead of the oil 52.

Furthermore, the structures of the liquid crystal display element 11 and the color filter element 12 are not limited to those described in the above embodiments, and driving elements other than TFTs may be applicable. Moreover, the present invention is also applicable to a display element in a passive driving system.

### INDUSTRIAL APPLICABILITY

As described above, the present invention is useful for a display device, and particularly suited for improving brightness in displaying white.

1. A display device, comprising:
a display element including a plurality of first sub-pixels;
a color filter element stacked on the display element, and including a plurality of second sub-pixels arranged to overlap the respective first sub-pixels of the display element; and
a light source emitting white light toward the color filter element and the display element, wherein
the display device performs display with light from the light source transmitted through the first sub-pixels and the second sub-pixels, and
each of the second sub-pixels of the color filter element includes a color region of which area is changed by electrowetting.

2. The display device of claim 1, wherein
the color filter element includes a plurality of pixels each of which includes a group of
one of the second sub-pixels having a red (R) color region,
one of the second sub-pixels having a green (G) color region, and
one of the second sub-pixels having a blue (B) color region.

3. The display device of claim 1, wherein the display element is a liquid crystal display element.

4. The display device of claim 1, wherein the display element is an electrowetting display element.

5. The display device of claim 1 4, wherein
the color filter element includes a first substrate, and a second substrate facing the first substrate with a partition wall segmenting the second sub-pixels interposed therebetween,
a first transparent electrode, an insulating film, and a hydrophobic film are sequentially stacked on the first substrate,
a second transparent electrode is stacked on the second substrate,
hydrophilic first solution and hydrophobic second solution, either one of which is colored, are enclosed between the second transparent electrode and the hydrophobic film in each of the second sub-pixels,
a voltage supply for applying a voltage between the first and second transparent electrodes is connected to the first and second transparent electrodes, and
a surface of the hydrophobic film at the side of the second substrate is hydrophobic where the voltage supply applies no voltage between the first and second transparent electrodes, and is hydrophilic where the voltage supply applies a voltage between the first and second transparent electrodes.

6. The display device of claim 5, wherein
the first solution is water, and
the second solution is oil.

7. The display device of claim 5, wherein the hydrophobic film is formed of an SiO₂ film having an OH group on a surface.
